(19) United States
(12) Patent Application Publication
(10) Pub. No.: US 2009/0218356 A1
(43) Pub. Date: Sep. 3, 2009

(54) CONTAINER FOR FOOD WITH MODIFIED LID

(75) Inventor: Gregory Colacitti, Toronto (CA)

Correspondence Address: Pabst Patent Group LLP, 1545 PEACHTREE STREET NE, SUITE 320, ATLANTA, GA, 30309, US

(73) Assignee: Tripak Industrial Corp., Toronto (CA)

(21) Appl. No.: 12/395,186

(22) Filed: Feb. 27, 2009

Related U.S. Application Data
(60) Provisional application No. 61/031,963, filed on Feb. 27, 2008.

(51) Int. Cl. A47G 19/00; B65D 51/16; B29C 45/36

(52) U.S. Cl. 220/574; 220/23.83; 220/203.01; 264/299

(57) ABSTRACT

Plastic containers for storing and transporting food, which include one or more vents, an identifier and/or other descriptive element, or a combination thereof on the top of the lid, and methods for making and using the containers are described herein. The vent contains at least two sections separated by at least one divider. Preferably, the vent is circular and contains three sections. The lids are formed using a standard injection molding process, by first inserting into the facial pocket in a mold cavity an insert-component with the desired identifier or descriptive element and/or one or more holes for the placement of pins on the outer face of the insert-component. Pins with the desired vent design on the face of the pin are placed into each hole of the insert-component. Containers with a vent in the lid are useful for storing hot food. A user applies downward pressure on the vent, opening the vent and allowing steam to escape from the lid. As the steam escapes, the pressure inside the container equilibrates with the ambient pressure.

### CROSS-REFERENCE TO RELATED APPLICATIONS

This application claims priority to U.S. Ser. No. 61/031,963 filed on Feb. 27, 2008. The disclosure in the application listed above is hereby incorporated by reference.

### FIELD OF THE INVENTION

This invention generally relates to containers for storing and transporting food.

### BACKGROUND OF THE INVENTION

Various containers are used to store and transport food, particularly in the “take-out” food industry. Food storage containers are typically formed by mating a lid with a base. Preferred materials include plastics. Many different containers have been designed to prevent leakage of fluids during travel and prevent or reduce spoilage of foods.

When hot food is placed in a container, steam rises from the food increasing the pressure within the container. The lid on the container often rises and bubbles outward from the container, deforming the container. If multiple containers are stacked on top of each other, this deformation will destabilize the stack of containers, increasing the likelihood that the containers will tip and food will leak out of the container.

Some of the available lids are designed to allow the steam to escape from the container, and thereby prevent deformation of the lid. However the vent on these lids is typically formed by applying pressure to a perforated area on the lid. Thus these containers are not air tight due to the presence of a perforated area on the lid. These containers are also prone to spilling liquids out of the container.

Containers used in the take-out food industry are generally generic containers, void of any identifiers as to the source of the food. Customized containers are expensive to produce. However, restaurants would use customized containers, such as containers with a corporate logo or other descriptive element, if the containers were affordable.

There is a need for improved containers for food storage.

There is also a need for customized, yet affordable containers for food storage.

Therefore it is an object of the invention to provide an improved food storage container.

It is a further object of the invention to provide a container that can be customized in a cost effective manner.

### BRIEF SUMMARY OF THE INVENTION

Containers for storing and transporting food, which include one or more vents, an identifier and/or other descriptive element, or a combination thereof on the top of the lid, and methods for making and using the containers are described herein. The base and the lid are formed by injection molding. The vent can be in any suitable shape and contains at least two sections separated by at least one divider. In the preferred embodiment, the vent is circular and contains three sections, each of which is separated from the other sections by a divider. The lids are formed by removing a center portion from the mold cavity to form a facial pocket in the cavity. Then an insert-component with the desired identifier or descriptive element and/or one or more holes for the placement of pins on the outer face of the insert-component is selected and inserted into the facial pocket in the mold cavity. If the insert-component contains one or more holes for the insertion of one or more pins, then the same number of pins, which have the desired vent design on the face of the pin, as the number of holes is selected and one pin is placed into each hole of the insert-component. Then the insert component and/or pin(s) are locked in place with a suitable locking system and a standard injection molding process is used to form the lid. Containers with lids containing one or more vents are particularly useful for transporting and storing hot food. The vent is opened when a user applies downward pressure on the vent, typically using his/her finger. This allows steam to escape from the lid. As the steam escapes, the pressure inside the container equilibrates with the ambient pressure, thereby preventing deformation of the lid and/or enabling the lid to return to its original shape. In a preferred embodiment, the dividers self- seal, when the pressure inside the container equilibrates with the ambient pressure (e.g. returns to Standard Pressure).

### BRIEF DESCRIPTION OF THE DRAWINGS

FIG. 1 is a perspective view of a container, where the lid contains an identifier and descriptive element in the central, flat portion of the top.

FIG. 2 is a plane view of the top of a lid, where the lid contains a vent in one corner of the central, flat portion of the top.

FIG. 3 is an enlarged view of a vent.

FIG. 4 is a cross-sectional view of a pin used to form the vent.

FIGS. 5A and 5B are perspective views of the insert-component being inserted into the facial pocket in the mold cavity plate in the midst of the insertion process (FIG. 5A) and in the fully inserted position (FIG. 5B).

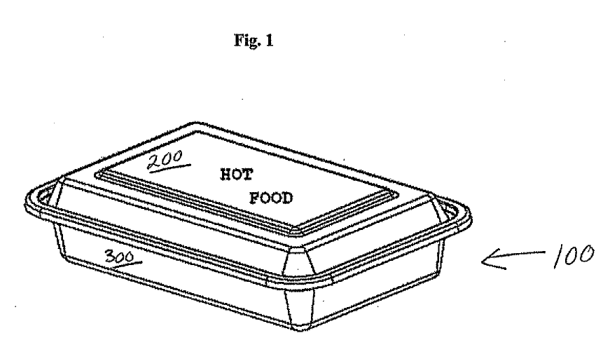

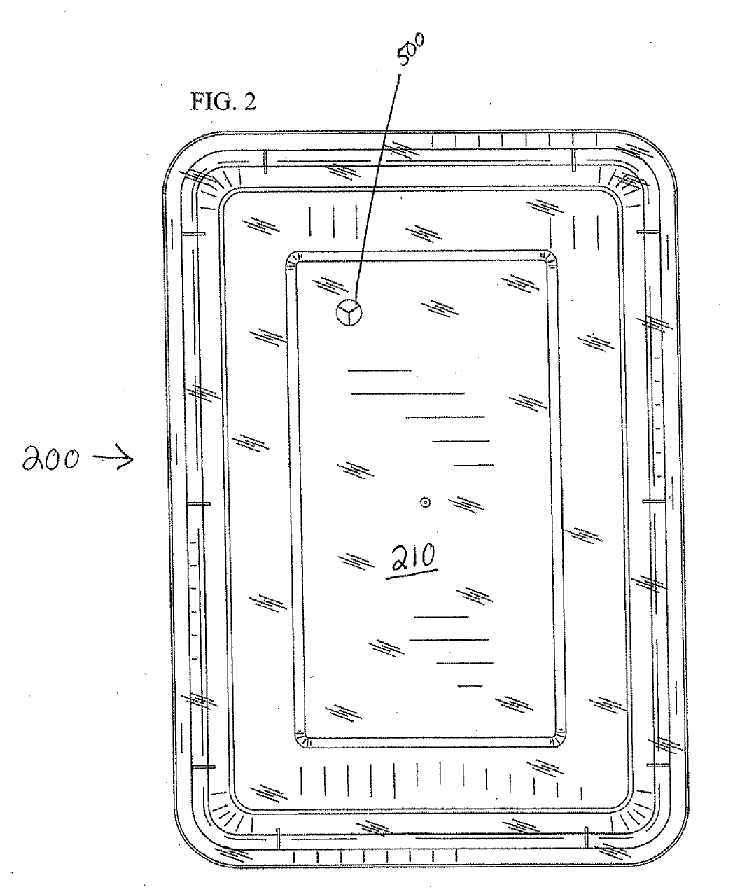

### DETAILED DESCRIPTION OF THE INVENTION

### I. Containers

The containers 100 are formed by mating a lid 200 with a base 300. The containers are preferably resealable, allowing them to be reused. The lid and base are plastic. Preferably the lid 200 and base 300 are formed from dishwasher-safe and microwave-safe materials. Suitable materials include polyethylene (including high density and low density polyethylene), polypropylene, polyvinylchloride, polyethylene terephthalate, polyhydroxyalkanoates, poly(lactic acid), poly(glycolic acid), poly(lactic-co-glycolic acid), and combinations thereof. In the preferred embodiment, the containers are formed of polypropylene. The lid 200 and base 300 are formed by injection molding processes.

a. Lid

Any lid formed by injection molding may be modified as described herein to contain an identifier and/or descriptive element, and/or one or more vents on the top of the lid.

The lid 200 may have any suitable geometry, such as square, rectangle, polygon, circle, or oblong-shape or oval. Preferably the lid 200 is in the shape of a circle, rectangle or oblong-shape or oval. The shapes of the base and the lid are selected to mate with each other and form an air tight, leak-resistant seal upon mating.

Preferably the lid 200 is stackable with respect to another lid 200 of the same shape, so that a plurality of lids 200 having the same size and shape can be stacked with one lid placed on top of another lid. This design minimizes the space required to store multiple lids.

b. Base

Any base formed by injection molding may be used to form the container, as long as the base mates with the lid. The base 300 may have any suitable geometry, such as square, rectangle, polygon, circle, or oblong-shape or oval. Preferably the base 300 is in the shape of a circle, rectangle or oblong-shape or oval. The shapes and sizes of the base and the lid are selected to mate with each other and form an air tight, leak-resistant seal upon mating.

Preferably the base 300 is stackable with respect to another base 300 of the same shape, so that multiple bases 300 can be easily stacked with base upon base. This design minimizes the required storage area for multiple bases.

Optionally, the base may have one or more partitions located inside the base to separate the inside of the base into more than one compartment. Optionally, the lid contains one or more partitions that are mateable with the one or more partitions inside the base.

Optionally, the base is modified as described herein with respect to the lid to contain an identifier and/or other descriptive element on the bottom of the base.

c. Vent

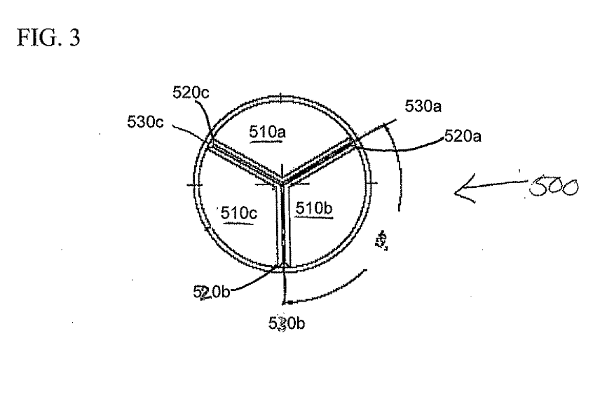

Any lid 200 formed via injection molding may be modified to include one or more vents 500 on the top 210 of the lid. The vent contains at least two sections 510, preferably the vent contains three sections 510a, b and c (see e.g. FIG. 3). Optionally the vent contains more than three sections. The sections are thinner than the thickness from the top of the lid, In a preferred embodiment, the thickness for the sections is about 15% of the thickness of the top of the lid, more preferably the thickness for the sections is about 14% of the thickness of the top of the lid. For example, if the top of the lid is about 0.02 inches thick, in a preferred embodiment, each section of the vent is about 0.003 inches thick.

Each section is separated from one or more sections by divider 520 having a thickness that is less than the thickness of a section. The dividers can be opened by applying pressure, such as via manual application of pressure, to the vent. The dividers 520 are typically slightly raised relative to the height of the sections 510 of the vent on the top of the lid.

The vent can be in any suitable shape, including but not limited to square, rectangle, polygon, circle, or oval. In the preferred embodiment, the vent is circular.

The preferred embodiment of the vent is illustrated in FIG. 3. In the preferred embodiment, the vent is circular and has three identically shaped sections 510a, b and c, each of which is separated from the other two by a divider 520a or b that is thinner compared to the thickness of the plastic that forms the sections 510. Each divider is 120° away from the other dividers, rotating about a point in the center of the circle. In a preferred embodiment, the diameter of the circular vent ranges from 0.2 to 0.5 inches, preferably from 0.3 to 0.4 inches, and most preferably is about 0.3 inches. Preferably the dividers angle upward from each section at a 45° angle, and form a tip 530 at the highest point of the divider. Preferably the tips 530 have widths ranging from 0.004 to 0.006 inches, preferably from 0.005 to 0.006 inches, and most preferably about 0.005 inches. Preferably the dividers 520 have an overall width ranging from 0.01 to 0.03 inches, and more preferably the overall width is about 0.02 inches.

In a preferred embodiment, the width and thickness of the dividers are selected to allow the dividers to self-seal after they are opened and the pressure inside of the container equilibrates with the ambient pressure.

d. Identifier and/or Descriptive Element on the Top of the Lid

The identifier and/or descriptive element on the top 210 of the lid may be used to indicate the source of the food, a tradename or trademark, such as a company or restaurant name and/or logo. Alternative or additional identifiers and/or descriptive elements may be used in place of a corporate logo, including but not limited to identifiers as to the type of food inside the container, warning labels (e.g. “hot food”), etc.

### II. Method of Making the Containers

The containers described herein are manufactured using conventional injection molding processes. In the preferred embodiment, the process is a high speed injection molding process.

Plastics are frequently molded into containers with desired shapes through the use of injection molding equipment having an injection unit and a clamping unit. In a conventional injection molding process, after the cavity mold plate (the “cavity”) and core mold plates (the “core”) are each attached to a base. The cavity and core are movable relative to each other between open and closed positions and have opposing faces that meet and define the molding chamber between them, when the cavity and core are in the closed position. The molding chamber defines the shape of a molded article. Typically, one half of the mold is affixed to a stationary platen (often referred to as the “A side” of the mold) while the other half (often referred to as the “B side” of the mold) is affixed to a movable platen.

Often, interchangeable mold inserts are used in injection molds for container lids. An example of such an insert is a closure insert or an engraving insert for container lids. Closure inserts mold opening configurations, such as crimp-on, threaded and push in styles into the lid, and thereby allow various closure styles to be utilized with a lid. Engraving inserts allow a custom engraving to be placed on the lid.

In some methods, such inserts are secured to the cavity from the face of the cavity by means of a mounting screw. In a preferred method, the inserts are secured to the cavity from the rear of the cavity, most preferably using an insertion and locking system that allows for insertion and removal of the inserts without removing the core and/or cavity mold plates. In a particularly preferred method, at least one of the faces of the core or the cavity contains a facial pocket, the facial pocket is connected to a passageway that extends through the plate and into the base, and the insert is attached to an insert rod, which is inserted into the passageway, thereby inserting the insert into the facial pocket. Then the insert and insert rod are locked in place with a suitable locking system.

A pellet or powder resin is melted within a heating chamber of the injection unit. The injection unit includes a piston or ram that pushes the melted plastic past a spreader, often referred to as a “torpedo”, that spreads the melted plastic. This enables improved thermal contact with the heating chamber and thus improves the flow of the melted plastic. The melted plastic then converges at a nozzle which is connected to a sprue located within the mold. The sprue is connected to a gate by a runner that is formed in the mold through which the melted plastic flows. The gate directs the flow of melted plastic into a mold cavity and thereby forms the desired part. Additionally, the gate limits backflow of the melted plastic. Further, the clamping unit provides a clamping force to keep the mold together during the injection molding process.

a. Making a Lid that Contains an Identifier or other Descriptive Element on the Top of the Lid

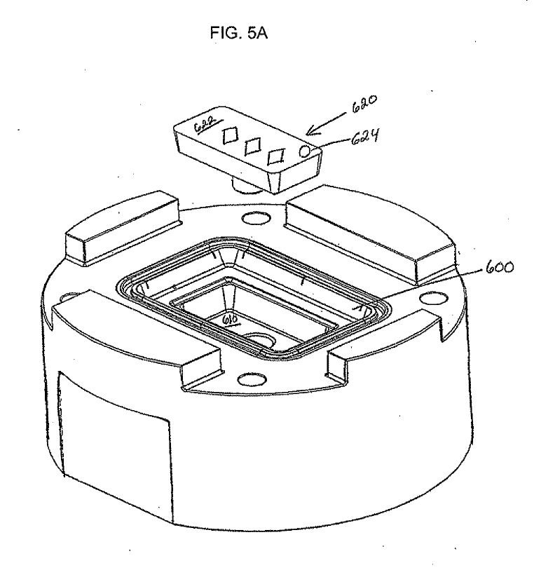

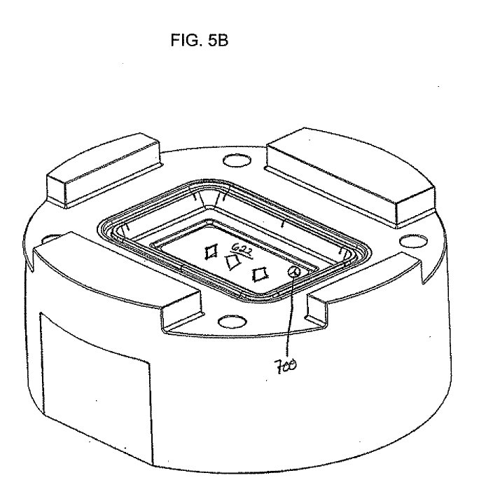

To form a lid containing an identifier and/or other descriptive element on the top of the lid, the mold is assembled by removing a center portion (not shown in figures) from the mold cavity 600 to form a facial pocket 610 in the mold cavity. Then an insert-component 620 with the desired identifier or descriptive element on the outer face 622 of the insert-component is selected and inserted into the facial pocket 610 in the mold cavity 600 (see FIGS. 5A and B). Finally the insert-component is locked into place using a suitable locking system.

After the mold is assembled, a standard injection molding process is used to form the lid.

b. Making a Lid that Contains One or More Vents on the Top of the Lid

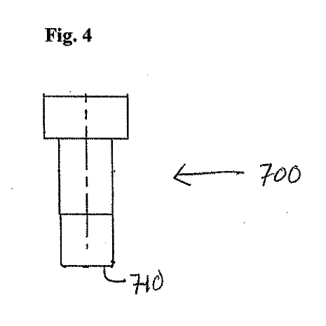

To form a lid containing one or more vents on the top of the lid, the mold is assembled by removing a center portion (not shown in figures) from the mold cavity plate 600 to form a facial pocket 610 in the cavity. Then an insert-component 620 containing one or more holes 624 in the desired locations, which correspond with the locations of the one or more vents, is selected and inserted into the facial pocket 610 in the mold cavity 600. A pin insert 700 with the desired vent shape on the face 710 of the pin insert 700 (see FIG. 4) is inserted into each hole 624 of the insert-component. Finally the insert-component 624 and pin(s) 700 are locked into place using a suitable locking system.

After the mold is assembled, a standard injection molding process is used to form the lid.

c. Making a Lid that Contains Both an Identifier or Other Descriptive Element and One or More Vents on the Top of the Lid

To form a lid containing both an identifier and/or other descriptive element and one or more vents on the top of the lid, the mold is assembled by removing a center portion (not shown in figures) from the mold cavity 600 to form a facial pocket 610. Then an insert-component 620 with the desired identifier or descriptive element on the outer face 622 of the insert-component and one or more holes 624 in the desired locations, which correspond with the locations of the one or more vents, is selected and inserted into the facial pocket 610 in the mold cavity plate 600. A pin insert 700 with the desired vent shape on the face 710 of the pin insert 700 is inserted into each hole 624 of the insert-component 620 (see FIGS. 5A and 5B). Finally the insert-component 624 and pin insert(s) 700 are locked into place using a suitable locking system.

After the mold is assembled, a standard injection molding process is used to form the lid.

III. Uses for the Containers

The containers are designed to be used to store and transport food. However, the containers may be used to store a variety of non-food materials. In the preferred embodiment, the containers are designed for use by restaurants, particularly for sending food home with a customer, e.g. “take-out” food. Containers with lids containing one or more vents are particularly suitable for transporting and/or storing hot food.

In one embodiment, the container includes a base and a lid having at least one vent on the top of the lid. If hot food is placed inside the container, steam will rise from the hot food inside of the container, and the vapor pressure inside the container will increase, causing the lid to deform and rise up. If at least one container is stacked on top of the container with the hot food (the “first container”), then deformation of the lid on the first container can cause displacement of the container placed on top of the lid (the “second container”), possibly spilling the contents of the second container. To prevent this from occurring, a user can apply a downward pressure, typically using his/her finger, on the vent in the lid of the container, thereby opening the dividers in the vent and allowing the steam to escape from the container. As the steam escapes, the pressure inside the container equilibrates with the ambient pressure, thereby preventing deformation of the lid and/or enabling the lid to return to its original shape.

In a preferred embodiment, the dividers self-seal, when the pressure inside the container equilibrates with the ambient pressure.

In another embodiment, the containers contain an indicator or descriptive element on the top of the lid. These containers are particularly useful for stores and/or restaurants to identify themselves and/or the contents of the food to the customer. Optionally, the lid also contains one or more vents to be used as described above to prevent deformation of the lid and/or return the lid to its original shape, when the container is used to transport and/or store hot food.

Unless defined otherwise, all technical and scientific terms used herein have the same meanings as commonly understood by one of skill in the art to which the disclosed invention belongs. Publications cited herein and the materials for which they are cited are specifically incorporated by reference.

Those skilled in the art will recognize, or be able to ascertain using no more than routine experimentation, many equivalents to the specific embodiments of the invention described herein. Such equivalents are intended to be encompassed by the following claims.

I claim:

1. A container for storing and transporting food consisting of a lid and a base, wherein the lid comprises one or more vents on the top of the lid, wherein the lid and base are plastic, and wherein the shapes of the base and the lid are selected to mate with each other and form an air tight, leak-resistant seal upon mating.

2. The container of claim 1, wherein the lid further comprises an indicator, descriptive element, or both on the top of the lid.

3. The container of claim 1, wherein the lid comprises one vent on the top of the lid.

4. The container of claim 1, wherein the one or more vents are circular.

5. The container of claim 4, wherein the one or more vents comprise three identically shaped sections, each of which is separated from the other sections by a divider.

6. The container of claim 5, wherein the thickness of the sections is about 15% of the thickness of the top of the lid.

7. The container of claim 6, wherein the thickness of the dividers is less than the thickness of the sections.

8. The container of claim 1, wherein the lid and base are formed by injection molding.

9. A plurality of containers as defined by claim 1, wherein the containers are stackable with respect to each other.

10. A method for forming a lid for a container for storing and transporting food, comprising
a) assembling a mold for the lid by removing a center portion from the mold's cavity to form a facial pocket in the cavity,
b) selecting an insert-component comprising a desired identifier or descriptive element on the outer face of the insert-component,
c) inserting the insert-component into the facial pocket in the cavity,
d) locking the insert-component in place using one or more locking elements, and
e) injecting melted plastic into the mold using a high speed injection molding process.

11. The method of claim 10, wherein the insert-component further comprises one or more holes,
wherein the method further comprises, after step c, inserting a pin insert with the desired vent shape on the face of the pin insert into each hole of the insert-component, and
wherein step d further comprises locking each pin insert in place using one or more locking elements.

12. A method for forming a lid for a container for storing and transporting food, comprising
a) assembling a mold for the lid by removing a center portion from the mold's cavity to form a facial pocket in the cavity,
b) selecting an insert-component comprising one or more holes in selected locations of the insert-component,
c) inserting the insert-component into the facial pocket in the cavity,
d) inserting a pin insert with the desired vent shape on the face of the pin insert into each hole of the insert-component,
e) locking the insert-component and each pin insert in place using one or more locking elements, and
f) injecting melted plastic into the mold using a high speed injection molding process.

13. The method of claim 12, wherein the insert-component comprises one hole.

14. The method of claim 13, wherein the insert-component is rectangular, and wherein the hole is in one corner of the insert-component.

15. A method for storing or transporting hot food, comprising placing the hot food in a plastic container, wherein the container consists of a lid and a base, wherein the lid comprises one or more vents, wherein the vents comprise at least two sections, each of which is separated from at least one other section by a divider, wherein the thickness of the divider is less than the thickness of the sections, and
manually applying pressure to the one or more vents to pierce the plastic in the divider and thereby open the vents.

16. The method of claim 15, wherein the lid comprises one vent on the top of the lid.

17. The method of claim 15, wherein the one or more vents are circular.

18. The method of claim 17, wherein the one or more vents comprise three identically shaped sections.

19. The method of claim 18, wherein the thickness of the sections is about 15% of the thickness of the top of the lid.

20. The method of claim 15, further comprising the step of self-sealing the vents after the pressure inside of the container equilibrates with ambient pressure.
